(19) United States
(12) Patent Application Publication
(10) Pub. No.: US 2024/0059091 A1
(43) Pub. Date: Feb. 22, 2024

(54) SHEET FOR INKJET PRINTING

(71) Applicant: LINTEC CORPORATION, Tokyo (JP)

(72) Inventors: Takuma OKUBO, Hasuda-shi, Saitama (JP); Nana SUZUKI, Toda-shi, Saitama (JP)

(73) Assignee: LINTEC CORPORATION, Tokyo (JP)

(21) Appl. No.: 18/270,755

(22) PCT Filed: Jan. 7, 2021
(86) PCT No.: PCT/JP2021/000368

§ 371 Date: Jul. 3, 2023

(51) Int. Cl. B41M 5/50; B41M 5/52

(52) U.S. Cl. CPC B41M 5/506; B41M 5/5218

(57) ABSTRACT

An object is to provide an inkjet printing sheet that can suppress uneven printing by suppressing variation in the interference among dots in an ink-receiving layer surface. This object was achieved by a sheet for inkjet printing, the sheet having a multilayer structure including in this order an ink-receiving layer, a base material, a pressure sensitive adhesive layer, and a release liner, the release liner including a silicone-based release agent layer on a contact face with the pressure sensitive adhesive layer, the ink-receiving layer including a composition for forming ink-receiving layer containing a resin and a silicone-based leveling agent. A content of the silicone-based leveling agent is 0.005 parts by mass or greater and less than 0.30 parts by mass per 100 parts by mass of the resin.

### TECHNICAL FIELD

The present invention relates to a sheet for inkjet printing.

### BACKGROUND ART

An inkjet recording method is a method of making a record where dots are formed by spewing ink droplets and allowing the ink to adhere onto inkjet printing media. The inkjet recording method is rapidly widespread because of its benefits such as the ease of obtaining high quality images in full color, the ease of increasing speed, and low running costs.

Furthermore, with the spread of the inkjet recording method, various proposals are being made for inkjet printing media. For example, a sheet for inkjet printing having a multilayer structure including in this order an ink-receiving layer, a base material, a pressure sensitive adhesive layer, and a release liner, the sheet being able to serve as a label by attaching to various components, has been proposed.

Note that, in the present description, an “ink-receiving layer” is a part where ink for inkjet printing is to be provided and means a layer having a function of fixing a printed portion formed by the provided ink for inkjet printing.

In recent years, various ink-receiving layers have been proposed. For example, an ink-receiving layer containing a vinyl chloride resin and a vinyl acetate resin (see Patent Document 1 and the like) and an ink-receiving layer containing a poly(vinyl butyral) (see Patent Document 2 and the like) are known.

### CITATION LIST

### Patent Literature

Patent Document 1: JP 2019-172877 A
Patent Document 2: JP 2007-130776 A

### SUMMARY OF INVENTION

### Technical Problem

In the course of conducting research and development on ink-receiving layers, the inventors encountered an issue of uneven printing. Specifically, when ink droplets are spewed on an ink-receiving layer by an inkjet recording method and dots are formed, in a part of region in the ink-receiving layer surface, wettability of dots decreases, dots do not appropriately interfere with each other, variation in interference among dots occurs in the ink-receiving layer surface, and thus printing in the part of the region becomes more faint than normal, causing uneven printing to be visible when the entire printed portion formed on the ink-receiving layer is observed, which is an issue.

The present invention has been completed to solve the issues described above, and an object of the present invention is to provide an inkjet printing sheet that can suppress uneven printing by suppressing variation in the interference among dots in the surface of an ink-receiving layer.

### Solution to Problem

As a result of diligent research to solve the issues described above, the present inventors found that the issues can be solved by blending an extremely small amount of silicone-based leveling agent in a composition for forming ink-receiving layer to form an ink-receiving layer.

That is, the present invention relates to [1] to [6] below:

[1] A sheet for inkjet printing, the sheet having a multilayer structure including in this order an ink-receiving layer, a base material, a pressure sensitive adhesive layer, and a release liner,
the release liner including a silicone-based release agent layer on a contact face with the pressure sensitive adhesive layer,
the ink-receiving layer containing a composition for forming an ink-receiving layer containing a resin and a silicone-based leveling agent,
in which a content of the silicone-based leveling agent is 0.005 parts by mass or greater and less than 0.30 parts by mass per 100 parts by mass of the resin.

[2] The sheet for inkjet printing according to [1] above, in which the silicone-based leveling agent is a polyether-modified silicone oil.

[3] The sheet for inkjet printing according to [1] or [2] above, in which the sheet is a rolled body obtained by winding into a roll form or a wound body obtained by winding around a core material.

[4] A method of use of the sheet for inkjet printing according to any one of [1] to [3] above, the method including forming a printed portion on an ink-receiving layer (A) of the sheet for inkjet printing by using an ink for inkjet printing.

[5] A method for producing a printed article, the method including forming a printed portion on an ink-receiving layer (A) of the sheet for inkjet printing according to any one of [1] to [3] above by using an ink for inkjet printing.

[6] A printed article comprising a printed portion formed by an ink for inkjet printing provided on an ink-receiving layer (A) of the sheet for inkjet printing according to any one of [1] to [3] above.

### Advantageous Effects of Invention

According to the present invention, an inkjet printing sheet that can suppress uneven printing by suppressing variation in the interference among dots in the surface of an ink-receiving layer can be provided.

### BRIEF DESCRIPTION OF DRAWINGS

FIG. 1 is a schematic cross-sectional view illustrating an example of a sheet for inkjet printing according to an aspect of the present invention.

FIG. 2 is a schematic cross-sectional view illustrating a multilayer state of two sheets for inkjet printing in pretreatment performed before various evaluations in Examples.

FIG. 3 is a whole photograph (photograph in place of drawing) of an ink-receiving layer surface of a sheet for inkjet printing in Comparative Example I-1.

FIG. 4 is a photograph in place of a drawing, the photograph indicating optical microscope observation results for a dark part and a light part formed on an ink-receiving layer surface of a sheet for inkjet printing in Comparative Example I-1.

### DESCRIPTION OF EMBODIMENTS

In the present description, “active components (solid content)” refer to components excluding a diluent solvent, such as water or an organic solvent, from the components contained in a target composition.

In the present description, “(meth)acrylate” means both methacrylate and acrylate, and the same applies to similar terminologies.

In the present specification, the lower and upper limits of a preferable numerical range (for example, a range of content) described in series can each be independently combined. For example, from the description “preferably from 10 to 90, more preferably from 30 to 60”, the “preferred lower limit (10)” and the “preferred upper limit (60)” can be combined as “from 10 to 60”.

In the present description, the numerical values of examples are numerical values that can be used as an upper limit value or a lower limit value.

### Aspect of Sheet for Inkjet Printing of the Present Invention

The sheet for inkjet printing according to an embodiment of the present invention has a multilayer structure including in this order an ink-receiving layer, a base material, a pressure sensitive adhesive layer, and a release liner, the release liner including a silicone-based release agent layer on a contact face with the pressure sensitive adhesive layer, and the ink-receiving layer includes a composition for forming an ink-receiving layer containing a resin and a silicone-based leveling agent.

In the sheet for inkjet printing according to an embodiment of the present invention, a content of the silicone-based leveling agent is 0.005 parts by mass or greater and less than 0.30 parts by mass per 100 parts by mass of the resin.

The inventors of the present invention studied diligently to solve the issues described above. As a result, it was found that, by blending an extremely small amount of a silicone-based leveling agent in an ink-receiving layer, uneven printing can be suppressed by suppressing variation in the interference among dots in the ink-receiving layer surface.

The mechanism by which the effects of the present invention are exhibited is not clear, but is presumed to be as follows.

That is, by forming the sheet for inkjet printing having the multilayer structure into a rolled body or wound body, when the ink-receiving layer and a release liner back surface are brought into contact, an extremely small amount of the silicone component transfers onto the ink-receiving layer surface. As a result, in the ink-receiving layer surface, partial change in surface free energy occurs. In the region where the partial change in surface free energy occurs, the interference among dots becomes less than usual due to decrease in wettability of dots with respect to the ink-receiving layer compared to a region where the change in surface free energy is not occurring. It is presumed that, by this phenomenon, appropriate interference among dots that should have occurred is inhibited, thus the printed portion becomes more faint, causing uneven printing to be visually observed. The uneven printing is suppressed by suppressing variation in the interference among dots in the ink-receiving layer surface by blending an extremely small amount of a silicone-based leveling agent in an ink-receiving layer.

Regarding the sheet for inkjet printing according to an embodiment of the present invention, configuration of the sheet for inkjet printing, an ink-receiving layer, a base material, a pressure sensitive adhesive layer, and a release liner constituting the sheet for inkjet printing, a method for producing the sheet for inkjet printing, and use of the sheet for inkjet printing will be described in detail below.

### Configuration of Sheet for Inkjet Printing

The sheet for inkjet printing according to an embodiment of the present invention has a multilayer structure including in this order an ink-receiving layer, a base material, a pressure sensitive adhesive layer, and a release liner.

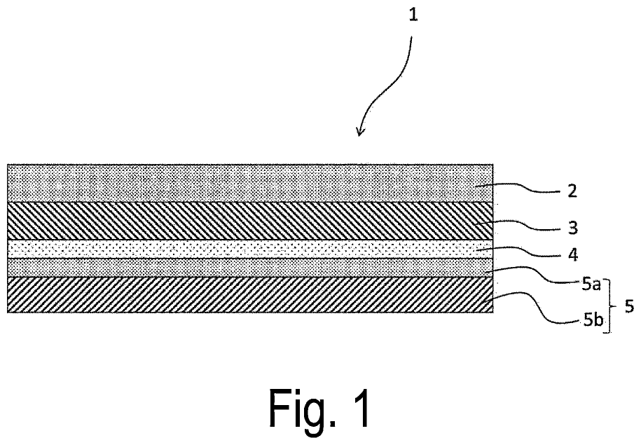

FIG. 1 illustrates a schematic cross-sectional view of one aspect of the sheet for inkjet printing according to an embodiment of the present invention. The sheet for inkjet printing 1 illustrated in FIG. 1 has a multilayer structure including an ink-receiving layer 2, a base material 3, a pressure sensitive adhesive layer 4, and a release liner 5 in this order. Furthermore, the release liner 5 includes a silicone-based release agent layer 5a and a support 5b, and the silicone-based release agent layer 5a is in contact with the pressure sensitive adhesive layer 4.

Note that, in the sheet for inkjet printing 1 illustrated in FIG. 1, the ink-receiving layer 2, the base material 3, the pressure sensitive adhesive layer 4, and the release liner 5 are laminated directly without interposing another layer. Thus, the sheet for inkjet printing 1 illustrated in FIG. 1 consists only of the ink-receiving layer 2, the base material 3, the pressure sensitive adhesive layer 4, and the release liner 5.

However, the sheet for inkjet printing 1 is not necessarily limited to such an embodiment. For example, another layer may be optionally provided at least in between the ink-receiving layer 2 and the base material 3 or in between the base material 3 and the pressure sensitive adhesive layer 4. Examples of another layer include a primer layer.

Furthermore, although the silicone-based release agent layer 5a and the support 5b may be directly laminated as illustrated in FIG. 1, another layer may be optionally provided in between the silicone-based release agent layer 5a and the support 5b. Examples of another layer include a filler layer.

### Ink-Receiving Layer

The ink-receiving layer includes a composition for forming ink-receiving layer containing a resin and a silicone-based leveling agent. By allowing the ink-receiving layer to contain an extremely small amount of the silicone-based leveling agent, variation in interference among dots in the ink-receiving layer surface is suppressed, and uneven printing is suppressed.

### Resin

The ink-receiving layer and the composition for forming ink-receiving layer contain a resin.

As the resin, a general resin that is used as a main agent of an ink-receiving layer can be used without particular limitation.

Note that, in the present description, “main agent” means a component contained with a largest amount among active components (solid content) in the composition for forming ink-receiving layer. Specifically, the content of the main agent is preferably 50 mass % or greater, more preferably 60 mass % or greater, and even more preferably 70 mass % or greater, with respect to the total amount of the active components (solid content) of the composition for forming ink-receiving layer. Furthermore, typically, the content is 99 mass % or less.

Note that the ink-receiving layer may be an energy ray curable ink-receiving layer, a thermosetting ink-receiving layer, or an ink-receiving layer having a cross-linked structure. The resin used as a main agent for the ink-receiving layer is appropriately selected in a manner that, for example, the ink-receiving layer becomes an ink-receiving layer of any one of these types.

In the present specification, “energy rays” means electromagnetic waves or charged particle beams having energy quanta. Examples of the energy rays include ultraviolet light, radioactive rays, and electron beams. The ultraviolet light can be irradiated by using, for example, a high-pressure mercury lamp, a fusion lamp, a xenon lamp, a black light, or an LED lamp as an ultraviolet ray source. The electron beam can be generated by an electron beam accelerator or the like and irradiated. In an aspect of the present invention, “energy rays” are preferably ultraviolet light.

In an aspect of the present invention, examples of the resin used as a main agent of the ink-receiving layer include acrylic resins, cellulose resins, and urethane resins.

As the cellulose resin, modified cellulose is preferred. Note that modified cellulose is a substance in which at least some of hydroxy groups of a cellulose molecule are replaced with other groups. Examples of substituent include alkyl groups such as a methyl group and an ethyl group; hydroxyalkyl groups such as a hydroxyethyl group and a hydroxypropyl group; acyl groups such as an acetyl group, a propionyl group, and a butyryl group. Specific examples of modified cellulose include cellulose acetate, cellulose acetate propionate, and cellulose acetate butyrate.

As the urethane resin, a water-based urethane polymer or a solvent-based urethane polymer is preferred, and a water-based urethane polymer is more preferred. Examples of water-based urethane polymer include polycarbonate-based urethane polymers, polycaprolactone-based urethane polymers, and polyester-based urethane polymers.

One type of these may be used alone, or a combination of two or more types of these may be used.

Note that, in an aspect of the present invention, because of environmental reasons, as the resin, a content of vinyl chloride resin is preferably small.

Specifically, the content of the vinyl chloride resin is preferably 10 mass % or less, more preferably 5 mass % or less, and even more preferably 1 mass % or less, with respect to the total amount of the active components (solid content) of the composition for forming ink-receiving layer, and yet even more preferably no vinyl chloride resin is contained.

Note that, in an aspect of the present invention, from the viewpoint of facilitating exhibition of the effects of the present invention, the resin used as the main agent of the ink-receiving layer is preferably a resin having a cross-linkable functional group, and more preferably an acrylic resin (A) having a cross-linkable functional group.

That is, in an aspect of the present invention, the ink-receiving layer is preferably an aspect of (I) or (II) below, and more preferably an aspect of (II) below.
(I) An ink-receiving layer having a cross-linked structure, the ink-receiving layer containing a resin having a cross-linkable functional group and a silicone-based leveling agent
(II) An ink-receiving layer having a cross-linked structure, the ink-receiving layer containing an acrylic resin (A) having a cross-linkable functional group and a silicone-based leveling agent

The aspect of (II) above, which is a more preferred aspect, will be described in detail below including the resin and additives used in combination with the resin.

“(II) An ink-receiving layer having a cross-linked structure, the ink-receiving layer containing an acrylic resin (A) having a cross-linkable functional group and a silicone-based leveling agent” is formed by using a composition for forming ink-receiving layer, the composition containing an acrylic resin (A) having a cross-linkable functional group, a cross-linking agent, and a silicone-based leveling agent.

Note that the ink-receiving layer and the composition for forming ink-receiving layer may contain another component besides the acrylic resin (A) having a cross-linkable functional group, the silicone-based leveling agent, and the cross-linking agent.

### Acrylic Resin (A) Having Cross-Linkable Functional Group

The acrylic resin having a cross-linkable functional group is preferably an acrylic resin (A1) having a constituent unit (a1) derived from a cross-linkable functional group-containing monomer (a1′) (hereinafter, also referred to as a monomer (a1′)).

Examples of the cross-linkable functional group of the monomer (a1′) include one or more selected from a hydroxyl group, a carboxy group, an amino group, and an epoxy group.

In other words, examples of the monomer (a1′) include a hydroxyl group-containing monomer, a carboxy group-containing monomer, an amino group-containing monomer, and an epoxy group-containing monomer. In addition, a monomer containing two or more cross-linkable functional groups selected from a hydroxyl group, a carboxy group, an amino group, an epoxy group, and the like can also be exemplified.

These monomers (a1′) may be used alone or in combination of two or more.

Among them, the monomer (a1′) is preferably a hydroxyl group-containing monomer and a carboxy group-containing monomer.

Examples of the hydroxyl group-containing monomer include hydroxyalkyl (meth)acrylates, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate; N-methylolated acrylamide; ε-caprolactone-modified hydroxy (meth)acrylate; and carbonate-modified (meth)acrylate.

Examples of the carboxy group-containing monomer include (meth)acrylic acid; a compound obtained by reacting a terminal hydroxyl group of the above-mentioned hydroxyl group-containing monomer with an acid anhydride such as one or more aliphatic dicarboxylic acid(s) selected from succinic anhydride, glutaric anhydride, and the like; and the like.

Here, the acrylic resin (A) having a cross-linkable functional group may be an acrylic copolymer (A2) having a constituent unit (a2) derived from an alkyl (meth)acrylate (a2′) (hereinafter, referred to as “monomer (a2′)”) together with the cross-linkable functional group-containing monomer (a1′).

The number of carbon atoms of the alkyl group of the monomer (a2′) is preferably 1 to 24. The number of carbon atoms in the alkyl group is preferably 2 to 20 from the viewpoint of adjusting the glass transition temperature (Tg) of the acrylic resin (A) to an appropriate range to exhibit the effect of the present invention more easily.

In addition, the alkyl group contained in the monomer (a2′) may be a linear alkyl group or a branched alkyl group.

Examples of the monomer (a2′) include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, 2-ethylhexyl (meth)acrylate, lauryl (meth)acrylate, tridecyl (meth)acrylate, and stearyl (meth)acrylate.

These monomers (a2′) may be used alone or in combination of two or more.

In the acrylic copolymer (A2) containing the constituent unit (a2), a content of the constituent unit (a2) is preferably 1 to 99 mass %, more preferably 5 to 95 mass %, and still more preferably 10 to 90 mass %, based on the total amount of the acrylic copolymer (A2).

The acrylic resin (A1) and the acrylic copolymer (A2) may be an acrylic copolymer (A3) further having a constituent unit (a3) derived from a monomer (a3′) other than the monomers (a1′) and (a2′).

Examples of the monomer (a3′) include olefins, such as ethylene, propylene, and isobutylene; halogenated olefins, such as vinyl chloride and vinylidene chloride; diene-based monomers, such as butadiene, isoprene, and chloroprene; (meth)acrylates having a cyclic structure, such as cyclohexyl (meth)acrylate, benzyl (meth)acrylate, isobornyl (meth)acrylate, dicyclopentanyl (meth)acrylate, dicyclopentenyl (meth)acrylate, dicyclopentenyloxyethyl (meth)acrylate, and imide (meth)acrylate; styrene, α-methylstyrene, vinyl toluene, vinyl formate, vinyl acetate, acrylonitrile, (meth)acrylamide, (meth)acrylonitrile, (meth)acryloylmorpholine, and N-vinylpyrrolidone.

In the acrylic copolymer (A3) containing the constituent unit (a3), a content of the constituent unit (a3) is preferably 1 to 99 mass %, more preferably 5 to 95 mass %, and still more preferably 10 to 90 mass %, based on the total amount of the acrylic copolymer (A3).

A molecular weight of the acrylic resin (A) having a cross-linkable functional group is not particularly limited, and the number average molecular weight is preferably from 3000 to 100000.

Note that the number average molecular weight is a value calibrated with polystyrene, determined by gel permeation chromatography (GPC) measurement using differential refractometer detection.

A hydroxyl value of the acrylic resin (A) having a cross-linkable functional group is preferably 5.0 mg KOH/g to 25.0 mg KOH/g, more preferably 6.0 mg KOH/g to 24.0 mg KOH/g, and still more preferably 7.0 mg KOH/g to 23.0 mg KOH/g.

When the hydroxyl value of the acrylic resin (A) having a cross-linkable functional group is equal to or more than the lower limit described above, the adhesion (ink adhesion) between the ink-receiving layer and the printed portion formed on the ink-receiving layer is easily improved. Also, the stability of the ink-receiving layer is easily improved.

When the hydroxyl value of the acrylic resin (A) having a cross-linkable functional group is equal to or less than the upper limit described above, the stability of the coating solution used in forming the ink-receiving layer is easily improved. In addition, it is easy to suppress shrinkage curl due to curing shrinkage of the ink-receiving layer caused by dense cross-linking.

Note that, in the present specification, the hydroxyl value of the acrylic resin (A) having a cross-linkable functional group means a value measured in accordance with JIS K 0070:1992.

An acid value of the acrylic resin (A) having a cross-linkable functional group is preferably 10.0 mg or less, more preferably 1.0 mg KOH/g to 9.0 mg KOH/g, and still more preferably 2.0 mg KOH/g to 8.0 mg KOH/g.

Note that, in this specification, the acid value of the acrylic resin (A) having a cross-linkable functional group means a value measured in accordance with JIS K 0070:1992.

The glass transition temperature (Tg) of the acrylic resin (A) having a cross-linkable functional group is preferably 100° C. or lower, more preferably 95° C. or lower, and even more preferably 90° C. or lower, from the viewpoint of further improving the adhesion (ink adhesion) between the ink-receiving layer and the printed portion. In particular, when the glass transition temperature (Tg) of the acrylic resin (A) having a cross-linkable functional group is lower than the curing temperature of the ink, the adhesion (ink adhesion) between the ink-receiving layer and the printed portion is further easily improved.

In addition, the glass transition temperature (Tg) of the acrylic resin (A) having a cross-linkable functional group is typically 30° C. or higher, preferably 40° C. or higher, and more preferably 50° C. or higher from the viewpoint of improving blocking resistance.

In the present specification, the glass transition temperature (Tg) of the acrylic resin (A) having a cross-linkable functional group means a value measured using a differential scanning calorimeter (Product name “DSC Q2000” available from TA Instruments Japan Inc.) at a heating rate of 20° C./min in accordance with JIS K 7121:1987.

A content of the acrylic resin (A) having a cross-linkable functional group is not particularly limited, and is preferably from 85 mass % to 98 mass %, more preferably from 87 mass % to 97 mass %, and even more preferably from 88 mass % to 96 mass %, with respect to the total amount of the active components (solid content) of the composition for forming ink-receiving layer, as long as the effect of the present invention is exhibited.

One type of acrylic resin (A) having a cross-linkable functional group may be used alone, or a combination of two or more types may be used.

### Cross-Linking Agent

The ink-receiving layer containing the acrylic resin (A) having a cross-linkable functional group as a resin contains a cross-linking agent together with the acrylic resin (A) having a cross-linkable functional group.

The cross-linking agent can be used without particular limitation as long as the cross-linking agent is a cross-linking agent that can perform a cross-linking reaction with the cross-linkable functional group contained in the acrylic resin (A) having the cross-linkable functional group. From the viewpoint of facilitating excellent adhesion between the ink-receiving layer and the base material, the cross-linking agent is preferably an isocyanurate compound, and more preferably a combination of an isocyanurate compound and a modified product of an isocyanurate compound. The cross-linking agent in which the isocyanurate compound and the modified product of an isocyanurate compound are combined exhibits particularly excellent adhesion with a base material containing a polyester resin, such as poly(ethylene terephthalate).

### Isocyanurate Compound

An isocyanurate compound is a trimer of 1,6-hexamethylene diisocyanate, and specifically is a compound of formula (1) below.

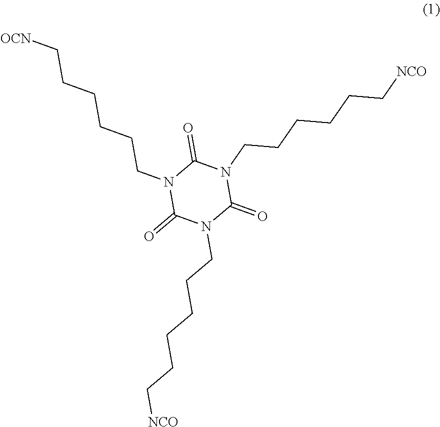

### Modified Product of Isocyanurate Compound

A modified product of the isocyanurate compound is a trimer of 1,6-hexamethylene diisocyanate, and has one or more tertiary amino group(s).

Examples of the method for introducing one or more tertiary amino group(s) into the compound of the formula (1) to form a modified product include a method for reacting a modifier with the compound of the formula (1), the modifier having a hydroxyl group and a tertiary amino group.

Examples of such a modifier include N,N-dimethylaminohexanol (e.g., KAOLIZER No. 25, available from Kao Corporation), N,N-dimethylaminoethoxyethoxyethanol (e.g., KAOLIZER No. 23NP, available from Kao Corporation), N,N-dimethylaminoethoxyethanol (e.g., KAOLIZER No. 26, available from Kao Corporation), N,N,N′-trimethylaminoethylethanolamine (e.g., TOYOCAT RX5, available from Tosoh Corporation), 2-[[3-(dimethylamino)propyl]methylamino] ethanol (e.g., POLYCAT 17, available from Evonik K.K.), and N,N-dimethylethanolamine (e.g., JEFFCAT DMEA, available from Huntsman Corporation).

The modifier may have a ring structure, and is preferably a compound having no ring structure as described above. Furthermore, the modifier is preferably an organic non-metal compound as described above that does not have a metal element. That is, the modifier is preferably an acyclic organic nonmetal compound having a hydroxyl group and a tertiary amino group.

The reaction between the compound of the formula (1) and the modifier is preferably performed by adding a compound of the formula (1) and a modifier in a nitrogen-purged reaction vessel, under stirring at a reaction temperature of 60° C. to 100° C. for 1 hour to 5 hours.

Preparation of Cross-Linking Agent Containing Isocyanurate Compound and Modified Product of Isocyanurate Compound

For the preparation of the cross-linking agent containing the isocyanurate compound and the modified product of the isocyanurate compound, for example, a ratio of added amounts of the compound of the formula (1) and the modifier charged in a reaction vessel is adjusted when the compound of the formula (1) and the modifier are reacted.

Regarding the ratio of the added amounts of the modifier to the compound of the formula (1), the content of the modifier is preferably 0.01 to 10 parts by mass, and more preferably 0.05 parts by mass to 5 parts by mass, based on 100 parts by mass of the compound of the formula (1). In this manner, among the compounds of the formula (1), only a portion of the compounds of the formula (1) is converted to a compound having one or more tertiary amino group(s), and it is possible to prepare the cross-linking agent containing the isocyanurate compound and the modified product of the isocyanurate compound.

Note that the content of the modified product of the isocyanurate compound is preferably 0.5 mol % to 10 mol %, more preferably 1 mol % to 5 mol %, with respect to the total amount of the isocyanurate compound and the modified product of the isocyanurate compound.

The content of the cross-linking agent is preferably 4.0 parts by mass or greater, more preferably 4.4 parts by mass or greater, even more preferably 5.0 parts by mass or greater, yet even more preferably 6.0 parts by mass or greater, and yet even more preferably 7.0 parts by mass or greater, per 100 parts by mass of the acrylic resin (A) having a cross-linkable functional group, from the viewpoint of further improving the adhesion (ink adhesion) between the ink-receiving layer and the printed portion. Also, the content is preferably 14.0 parts by mass or less, and more preferably 13.0 parts by mass or less.

One type of the cross-linking agent may be used alone, or a combination of two or more types of the cross-linking agents may be used.

Silicone-Based Leveling Agent

The ink-receiving layer and the composition for forming ink-receiving layer contain a silicone-based leveling agent.

By allowing the ink-receiving layer and the composition for forming ink-receiving layer to contain an extremely small amount of the silicone-based leveling agent, variation in interference among dots in the ink-receiving layer surface is suppressed, and uneven printing is suppressed.

It is presumed that the silicone-based leveling agent acts on suppressing partial disorder in surface free energy in the ink-receiving layer surface caused by a silicone component transferred from the release liner back surface to the ink-receiving layer, homogenizing the surface free energy in the ink-receiving layer surface, and suppressing variation in interference among dots in the ink-receiving layer surface. It is conceived that this action suppresses uneven printing.

The silicone-based leveling agent is a compound having a siloxane backbone, and specific examples thereof include at least one type selected from the group consisting of a compound having a siloxane backbone and an organic functional group and a compound having a siloxane backbone and an organic modification group. Note that the organic modification group means a group in which some of organic functional groups are replaced with other groups.

Specific examples of the silicone-based leveling agent include polyether-modified silicone oils such as DOWSIL (trade name) BY16-036 Fluid, DOWSIL SH28 Paint Additive, DOWSIL SF8428 Fluid, DOWSIL 501W Additive, DOWSIL L-7001 Fluid, DOWSIL FZ-2104 Fluid, DOWSIL L-7002 Fluid, and DOWSIL SF8427 Fluid (available from Dow Toray Co., Ltd.); alkyl-modified silicone oils such as DOWSIL (trade name) SF8416 Fluid, DOWSIL BY16-846 Fluid, DOWSIL SH203 Fluid, and DOWSIL 56 Additive (available from Dow Toray Co., Ltd.); carboxyl-modified silicone oils such as DOWSIL (trade name) BY-16-880 and DOWSIL BY16-750 Fluid; amino-modified silicone oils such as XIAMETER (trade name) OFX-8417 Fluid, DOWSIL (trade name) BY-16-849 Fluid, DOWSIL FZ-3785 Fluid, DOWSIL 16-872 Fluid, and DOWSIL 16-853U Fluid; and epoxy-modified silicone oils such as DOWSIL (trade name) SF8413 Fluid, DOWSIL SF8411 Fluid, DOWSIL BY16-839 Fluid, DOWSIL FZ-3736 Fluid, DOWSIL SF8421 EG Fluid, DOWSIL BY16-870 Fluid, DOWSIL BY16-876 Fluid, DOWSIL BY16-869 Fluid, and DOWSIL BY16-760 Fluid.

Among these, a polyether-modified silicone oil is more preferred.

One type of the silicone-based leveling agent may be used alone, or a combination of two or more types of the silicone-based leveling agents may be used.

In an embodiment of the present invention, the content of the silicone-based leveling agent is required to be 0.005 parts by mass or greater and less than 0.30 parts by mass per 100 parts by mass of the resin.

When the content of the silicone-based leveling agent is less than 0.005 parts by mass per 100 parts by mass of the resin, wettability of dots in some regions in the ink-receiving layer surface decreases, variation in interference among dots occurs in the ink-receiving layer surface, and thus uneven printing occurs.

Furthermore, when the content of the silicone-based leveling agent is 0.30 parts by mass or greater per 100 parts by mass of the resin, ink void and the like may occur due to repelling of ink. In addition, adhesion (ink adhesion) between the ink-receiving layer and the printed portion formed on the ink-receiving layer becomes poor.

Note that, from the viewpoint of effectively suppressing occurrence of uneven printing, the content of the silicone-based leveling agent is preferably 0.01 parts by mass or greater, more preferably more than 0.01 parts by mass, and even more preferably 0.02 parts by mass or greater, per 100 parts by mass of the resin.

Furthermore, from the viewpoint of facilitating more effective suppression of ink repelling, from the viewpoint of facilitating improvement of adhesion (ink adhesion) between the ink-receiving layer and the printed portion formed on the ink-receiving layer, and from the viewpoint of suppressing occurrence of uneven printing while a used amount of the silicone-based leveling agent is suppressed, the content of the silicone-based leveling agent is preferably 0.25 parts by mass or less, more preferably 0.20 parts by mass or less, and even more preferably 0.15 parts by mass or less, per 100 parts by mass of the resin.

### Other Additives

In an aspect of the present invention, the ink-receiving layer and the composition for forming ink-receiving layer may contain other additives besides the acrylic resin (A) having a cross-linkable functional group, the silicone leveling agent, and the cross-linking agent.

### Si Amount of Ink-Receiving Layer

In an aspect of the present invention, the Si proportion of the ink-receiving layer surface provided in the sheet for inkjet printing is preferably 0.24 at. % or greater, more preferably 0.30 at. % or greater, and even more preferably 0.32 at. % or greater, from the viewpoint of facilitating suppression of uneven printing.

Furthermore, from the viewpoints of ink repelling and excellent adhesion (ink adhesion) between the ink-receiving layer and the printed portion formed on the ink-receiving layer, the Si proportion is preferably less than 2.4 at. %, more preferably 2.2 at. % or less, and even more preferably 2.1 at. % or less.

The Si proportion can be calculated by the following equation based on the counts of silicon atom (Si₂ₚ), carbon atom (C₁ₛ), nitrogen atom (N₁ₛ), and oxygen atom (O₁ₛ) measured by X-ray photoelectron spectroscopy (XPS).

Si proportion (at. %)=[(Si₂ₚ count)/{(C₁ₛ count)+(N₁ₛ count)(O₁ₛ count)+(Si₂ₚ count)}]×100

### Base Material

The sheet for inkjet printing according to an embodiment of the present invention includes a base material.

The base material supports the sheet for inkjet printing and has a function as a support supporting the printed portion formed on the ink-receiving layer.

The base material is not particularly limited, and is preferably a resin sheet. When the base material is a resin sheet, excellent rigidity, flexibility, and the like of the sheet for inkjet printing and excellent handling of the sheet for inkjet printing are achieved. This is also advantageous from the viewpoint of reducing the production cost and weight of the sheet for inkjet printing.

Examples of the resin constituting the resin sheet include polyester resins such as polyethylene terephthalate, polybutylene terephthalate, and polyethylene naphthalate; polyolefin resins such as polyethylene and polypropylene; polystyrene; acrylonitrile-butadiene-styrene copolymers; cellulose triacetate; polycarbonate; urethane resins such as polyurethane and acrylic-modified polyurethane; polymethylpentene; polysulfone; polyether ether ketone; polyethersulfone; polyphenylene sulfide; polyimide resins such as polyetherimide and polyimide; polyamide resins; acrylic resins; and fluorine resins.

Among these, polyester resins and polyolefin resins are preferable, polyester resins are more preferable, and polyethylene terephthalate is even more preferable from the viewpoint of improvement in adhesion with the ink-receiving layer.

The resin sheet may be formed of only one kind of resin, or may be formed of two or more kinds of resins. When the resin sheet is formed of two or more kinds of resins, the resin sheet is preferably a multilayer body. Furthermore, the uppermost layer of the multilayer body (the layer in contact with the ink-receiving layer) is preferably a polyester resin, and more preferably polyethylene terephthalate, from the viewpoint of improvement in adhesion with the ink-receiving layer.

The resin sheet may be unstretched, or may be stretched in a uniaxial direction such as a longitudinal direction or a lateral direction, or a biaxial direction.

In addition, the resin sheet may contain an additive for a base material such as a surface conditioner, a plasticizer, an ultraviolet absorber, a light stabilizer, and a colorant together with these resins.

A content of the additive for the base material is preferably 10 mass % or less, more preferably 5 mass % or less, and even more preferably 3 mass % or less, with respect to the total amount of the base material.

A thickness of the base material is not particularly limited and is preferably from 15 μm to 300 μm, and more preferably from 30 μm to 200 μm.

### Pressure Sensitive Adhesive Layer

The sheet for inkjet printing according to an embodiment of the present invention includes a pressure sensitive adhesive layer.

By allowing the sheet for inkjet printing according to an embodiment of the present invention to have the pressure sensitive adhesive layer, the sheet for inkjet printing can be suitably used as a pressure sensitive adhesive sheet.

The pressure sensitive adhesive constituting the pressure sensitive adhesive layer is not particularly limited, and examples thereof include acrylic pressure sensitive adhesives and urethane pressure sensitive adhesives. When the sheet for inkjet printing is used for window display and the like, from the viewpoint of weatherability and the like, the pressure sensitive adhesive layer may be made of an acrylic pressure sensitive adhesive. Furthermore, in a case where redetachment from an adherend is required, the pressure sensitive adhesive layer may be made of a urethane pressure sensitive adhesive.

The pressure sensitive adhesive layer may contain another components such as ultraviolet absorbers, tackifiers, antioxidants, light stabilizers, softners, silane coupling agents, and fillers, as necessary. One type of these may be used alone, or two or more types of these may be mixed and used.

A thickness of the pressure sensitive adhesive layer is not particularly limited, and is preferably 5 μm to 100 μm, more preferably 10 μm to 70 μm, and even more preferably 15 μm to 50 μm, from the viewpoint of improving the handleability when the sheet for inkjet printing is used as a pressure sensitive adhesion sheet.

### Release Liner

The sheet for inkjet printing according to an embodiment of the present invention includes a release liner.

The pressure sensitive adhesion surface of the pressure sensitive adhesive layer included in the sheet for inkjet printing according to an embodiment of the present invention is covered with a release liner, and thus the pressure sensitive adhesion surface of the pressure sensitive adhesive layer can be suitably protected during transportation and storage of the sheet for inkjet printing.

Note that, in the sheet for inkjet printing according to an embodiment of the present invention, the release liner has a silicone-based release agent layer. When the sheet is formed into a rolled body or a wound body, an extremely small amount of the silicone component of the release liner may transfer to the release liner back surface. Thus, when the sheet for inkjet printing having the multilayer structure is formed into a rolled body or a wound body, an extremely small amount of the silicone component present in the release liner back surface may transfer to the ink-receiving layer.

The silicone component transferred from the release liner back surface to the ink-receiving layer causes partial disorder in surface free energy in the ink-receiving layer surface. As a result, variation in interference among dots occurs in the ink-receiving layer surface, and uneven printing occurs. However, according to an embodiment of the present invention, by actively blending an extremely small amount of the silicone-based leveling agent in the ink-receiving layer and the composition for forming ink-receiving layer, partial disorder in surface free energy of the ink-receiving layer surface is suppressed, the surface free energy in the ink-receiving layer surface is homogenized, variation of interference among dots in the ink-receiving layer surface is suppressed, and thus the uneven printing can be suppressed.

As the silicone-based release agent layer constituting the release liner, those ordinarily used for a release liner can be used without particular limitation.

Examples of the support constituting the release liner include sheet or paper that is ordinarily used for release liners.

Examples of the sheet include polyester resins such as polyethylene terephthalate, and polyolefin resins such as polyethylene resins and polypropylene resins.

Examples of the paper include papers such as wood-free paper, kraft paper, and glassine paper.

A thickness of the release liner is not particularly limited, and is preferably 10 μm to 150 μm, more preferably 20 μm to 130 μm, and even more preferably 30 μm to 120 μm.

### Method for Producing Sheet for Inkjet Printing

The method for producing the sheet for inkjet printing according to an embodiment of the present invention is not particularly limited, and is appropriately selected depending on the configuration of the sheet for inkjet printing.

A method for forming the ink-receiving layer preferably includes applying the composition for forming ink-receiving layer to one surface of the base material to form a coating, drying the coating, and then curing the coating.

Note that, in order to improve the workability of application to the base material, the composition for forming ink-receiving layer is preferably diluted with a diluent solvent to form a solution.

Examples of the diluent solvent include organic solvents such as methyl ethyl ketone, acetone, ethyl acetate, tetrahydrofuran, dioxane, cyclohexane, n-hexane, toluene, xylene, n-propanol, and isopropanol.

An active component (solid content) concentration of a solution of the composition for forming ink-receiving layer is preferably from 10 mass % to 50 mass %.

Examples of the method for applying the solution of the composition for forming ink-receiving layer include a Meyer bar coating method, a gravure coating method, a roll coating method, a knife coating method, and a die coating method.

A heating condition for drying the coating is, for example, a drying temperature of 60° C. to 120° C. and a drying time of 30 seconds to 3 minutes.

Appropriate conditions are appropriately employed for the curing conditions of the coating depending on the type of the ink-receiving layer.

For example, in a case where the ink-receiving layer is an ink-receiving layer having a cross-linked structure, the cross-linking conditions are not particularly limited and, for example, the coating may be left stand in a normal environment (for example, 23° C. and a relative humidity of 50%) for 1 day or longer and 14 days or shorter for cross-linking, or may be left stand in an environment of 40° C. to 60° C. for 1 day to 3 days for cross-linking. Furthermore, a drying step and a cross-linking step may be performed collectively.

The pressure sensitive adhesive layer contained in the sheet for inkjet printing of an aspect of the present invention is formed on another surface, in which the ink-receiving layer is not formed, of the base material.

For example, a composition (a composition for forming a pressure sensitive adhesive layer) for forming the pressure sensitive adhesive layer is applied on the other surface of the base material and thus the pressure sensitive adhesive layer is formed, and a release liner is laminated on the pressure sensitive adhesive layer. Alternatively, the composition for forming a pressure sensitive adhesive layer may be applied to the release surface (surface of the silicone-based release agent layer) of the release liner to form the pressure sensitive adhesive layer, and the pressure sensitive adhesive layer may be bonded to the other surface of the base material.

The method for applying the composition for forming a pressure sensitive adhesive layer is the same as that described above as the method for applying the composition for forming ink-receiving layer.

### Ink for Inkjet Printing

Examples of the ink for inkjet printing include ultraviolet curable ink, latex ink, and solvent ink. Among these inks for inkjet printing, the sheet for inkjet printing according to an embodiment of the present invention is effective to suppress uneven printing in inkjet printing using ultraviolet curable ink or latex ink, by which infiltration into the ink-receiving layer does not occur or is less likely to occur, and the sheet for inkjet printing is particularly effective to suppress uneven printing in inkjet printing using latex ink.

### Ultraviolet Curable Ink

The ultraviolet curable ink is ink that contains substantially no organic solvent and that is cured by irradiation of ultraviolet light. The ultraviolet curable ink contains a photopolymerizable monomer, a colorant which is a pigment or a dye, and a photopolymerization initiator that initiates a polymerization reaction.

In an aspect of the present invention, when the ink-receiving layer containing an acrylic resin described above is used, from the viewpoint of further improving adhesion between the ink-receiving layer and the printed portion, the ultraviolet curable ink preferably contains an acrylic monomer.

### Photopolymerizable Monomer

Examples of the photopolymerizable monomer include monofunctional acrylates, bifunctional acrylates, polyfunctional acrylates, and mixtures of these. Note that, as the photopolymerizable monomer, an acrylic monomer which is one of or a combination of these various acrylates may be used.

Examples of the monofunctional acrylate include hydroxypropyl acrylate (HPA), tetrahydrofurfuryl acrylate (THFA), phenol EO-modified (n=2) acrylate, 2-ethylhexyl EO-modified (n=2) acrylate, 2-hydroxy-3-phenoxypropyl acrylate, isobornyl acrylate (IBXA), and acryloylmorpholine (ACMO).

Examples of the bifunctional acrylate include hexanediol diacrylate (HDDA), neopentyl glycol diacrylate (NPGDA), tripropylene glycol diacrylate (TPGDA), neopentyl glycol hydroxypivalate diacrylate (MANDA), and bisphenol A EO-modified (n=4) diacrylate (A-BPE4).

Examples of the polyfunctional acrylate include trimethylolpropane triacrylate (TMPTA), pentaerythritol triacrylate (PETA), trimethylolpropane PO-modified (n=3) triacrylate (TMPPOA), ditrimethylolpropane tetraacrylate (DTMPTA), pentaerythritol tetraacrylate (PETTA), dipentaerythritol pentaacrylate (DPPA), and dipentaerythritol hexaacrylate (DPHA).

### Colorant

The ultraviolet curable ink typically contains a colorant.

As the colorant, various dyes, various pigments, and the like can be used.

### Photopolymerization Initiator

The photopolymerization initiator is generally a substance that initiates a polymerization reaction by ultraviolet light (UV) irradiation. As such a photopolymerization initiator, for example, one agent or a mixture of multiple agents of photopolymerization initiators may be used, and a combination of a photopolymerization initiator and a photosensitizer may be used. For example, the photopolymerization initiator may be a combination of multiple photopolymerization initiators with different excitation wavelengths or a substance obtained by adding a photosensitizer to this.

### Other Components

As other components, for example, various known dispersants, stabilizers, surfactants, and the like may be further blended as necessary.

### Latex Ink

The latex ink contains a liquid dispersion medium and a dispersoid made of a material containing at least a resin, the material being dispersed (emulsified and/or suspended) in the dispersion medium.

### Resin

The resin contained in the latex ink is not particularly limited, and examples thereof include a vinyl resin, an acrylic resin, a styrene resin, an alkyd resin, a polyester resin, a polyurethane resin, a silicone resin, a fluorine resin, an epoxy resin, a phenoxy resin, a polyolefin resin, and modified resins thereof (for example, modified resins modified to be water-soluble), and one or more selected therefrom can be used in combination.

In a case where the ink-receiving layer containing an acrylic resin as described above is used, the latex ink used in the sheet for inkjet printing according to an aspect of the present invention is preferably latex ink containing an acrylic resin from the viewpoint of further improving the adhesion between the ink-receiving layer and the printed portion.

### Dispersion Medium

The latex ink contains water as a dispersion medium.

### Colorant

The latex ink usually contains a colorant.

As the colorant, various dyes, various pigments, and the like can be used.

### Another Component

The latex ink may contain components besides those described above (other components).

Examples of such a component include a dispersant, an antifungal agent, a rust inhibitor, a pH adjuster, a surfactant, a plasticizer, an ultraviolet absorber, and a light stabilizer.

### Formation of Printed Portion

The printed portion by ink for inkjet printing is formed by providing ink for inkjet printing on the ink-receiving layer of the sheet for inkjet printing by an inkjet printing method.

Examples of the ink jet method include a piezo method and a thermal jet method.

When ultraviolet curable ink is provided as ink for inkjet printing, the ultraviolet exposure dose of the ultraviolet curable ink is not particularly limited and is preferably from 40 J/m² to 400 J/m².

When latex ink is provided as ink for inkjet printing, the heating temperature of the latex ink is not particularly limited and is preferably from 40° C. to 90° C.

By the method described above, a printed article having a printed portion, in which uneven printing is suppressed, by ink for inkjet printing on the ink-receiving layer of the sheet for inkjet printing can be obtained.

Note that the sheet for inkjet printing according to an embodiment of the present invention can suppress uneven printing even in inkjet printing performed particularly with a reduced ink amount. Specifically, even in a case where the ink amount is more than 10% and 70% or less (preferably from 15% to 60%, and more preferably from 20% to 50%), a printed portion without uneven printing can be formed.

### Use and the Like of Sheet for Inkjet Printing

The sheet for inkjet printing according to an embodiment of the present invention is to be used for printing using ink for inkjet printing.

According to an embodiment of the present invention, provided is a method of use of the sheet for inkjet printing described above, which includes forming a printed portion on an ink-receiving layer of the sheet for inkjet printing by using an ink for inkjet printing.

According to an embodiment of the present invention, provided is a method for producing a printed article, the method including forming a printed portion on an ink-receiving layer of the sheet for inkjet printing described above by using an ink for inkjet printing.

Furthermore, according to an embodiment of the present invention, provided is a printed article having a printed portion by ink for inkjet printing on the ink-receiving layer of the sheet for inkjet printing described above.

Note that, in the method of use, the method for producing a printed article, and a printed article according to an aspect of the present invention, examples of the ink for inkjet printing include ultraviolet curable ink, latex ink, and solvent ink.

Note that, in the method of use, the method for producing a printed article, and a printed article according to an aspect of the present invention, inkjet printing using ultraviolet curable ink or latex ink is preferably employed. Because the method of use, the method for producing a printed article, and a printed article according to an aspect of the present invention use the sheet for inkjet printing according to an embodiment of the present invention, uneven printing can be suppressed even in inkjet printing using ultraviolet curable ink or latex ink, by which infiltration into the ink-receiving layer does not occur or is less likely to occur, among these inks for inkjet printing.

Among the ultraviolet curable ink and the latex ink, latex ink may be suitably used.

Furthermore, in the method of use, the method for producing a printed article, and a printed article according to an aspect of the present invention, the ink amount during inkjet printing is preferably more than 10% to 70% or less, more preferably from 15% to 60%, and even more preferably from 20% to 50%.

According to the method of use, the method for producing a printed article, and a printed article according to an aspect of the present invention, uneven printing is to be adequately suppressed with the ink amount described above. Thus, this is useful for printing with the difference of density or gradation expression.

### EXAMPLES

The present invention will be specifically described with reference to examples below, but the present invention is not limited to the following examples.

### Example I

Sheets for inkjet printing including an ink-receiving layer containing an acrylic resin (A) having a cross-linkable functional group and a silicone-based leveling agent were evaluated.

### Examples I-1 to I-10 and Comparative Examples I-1 and I-2

Sheets for inkjet printing of Examples I-1 to I-10 and Comparative Examples I-1 and I-2 were prepared by the following procedures.

### Preparation of Composition for Forming Ink-Receiving Layer

Compositions for forming ink-receiving layer I-1a to I-10a and I-1b and I-2b having compositions listed in Table 1 were prepared.

Details of raw materials that were used are described below.
“Resin”: acrylic resin having a cross-linkable functional group, hydroxyl value 11.0 mgKOH/g, acid value 3.9 mgKOH/g, glass transition temperature (Tg) 90° C.
“Silicone-based leveling agent”: trade name “DOWSIL (trade name) SH28 Paint Additive” available from Dow Toray Co., Ltd., polyether-modified silicone oil
“Cross-linking agent”: partially modified product of isocyanurate compound (corresponding to the cross-linking agent containing an isocyanurate compound and a modified product of an isocyanurate compound described above)
“Other additive”: tin-based catalyst

Compositions for forming ink-receiving layer I-1a to I-10a and I-1b and I-2b having compositions listed in Table 1 were each diluted with a diluent solvent (ethyl acetate) to form a coating solution having an active component concentration of 10 mass % and supplied to production of a sheet for inkjet printing.

TABLE 1

| | | | Composition for forming ink-receiving layer | | | | | | | | | | | |
|---|---|---|---|---|---|---|---|---|---|---|---|---|---|---|
| | | Unit | I-1a | I-2a | I-3a | I-4a | I-5a | I-6a | I-7a | I-8a | I-9a | I-10a | I-1b | I-2b |
| Component | Resin | Mass % | 91.65 | 91.65 | 91.64 | 91.63 | 91.61 | 91.59 | 91.58 | 91.53 | 91.49 | 91.45 | 91.66 | 91.41 |
| of | | | | | | | | | | | | | | |
| composition | Silicone- | Mass % | 0.005 | 0.01 | 0.02 | 0.04 | 0.05 | 0.07 | 0.09 | 0.14 | 0.18 | 0.23 | 0.00 | 0.27 |
| for | based | | | | | | | | | | | | | |
| forming | leveling | | | | | | | | | | | | | |
| ink- | agent | | | | | | | | | | | | | |
| receiving | Cross- | Mass % | 7.88 | 7.88 | 7.88 | 7.88 | 7.88 | 7.88 | 7.88 | 7.87 | 7.87 | 7.86 | 7.88 | 7.86 |
| layer | linking | | | | | | | | | | | | | |
| (solid | agent | | | | | | | | | | | | | |
| content) | Other | Mass % | 0.46 | 0.46 | 0.46 | 0.46 | 0.46 | 0.46 | 0.46 | 0.46 | 0.46 | 0.46 | 0.46 | 0.46 |
| | additives | | | | | | | | | | | | | |
| | Total | Mass % | 100 | 100 | 100 | 100 | 100 | 100 | 100 | 100 | 100 | 100 | 100 | 100 |

| | | | | | | | | | | | | | |
|---|---|---|---|---|---|---|---|---|---|---|---|---|---|
| Silicone-based leveling | Part by | 0.005 | 0.01 | 0.02 | 0.04 | 0.06 | 0.08 | 0.10 | 0.15 | 0.20 | 0.25 | 0.00 | 0.30 |
| agent content per 100 | mass | | | | | | | | | | | | |
| parts by mass of resin | | | | | | | | | | | | | |

### Preparation of Sheet for Inkjet Printing

As a base material, a poly(ethylene terephthalate) sheet (thickness: 50 μm) including a primer layer was prepared.

In addition, a release liner (thickness: 50 μm) including a silicone-based release agent layer on one face of the poly(ethylene terephthalate) sheet was prepared.

Then, a coating solution of each of compositions for forming ink-receiving layer I-1a to I-10a and I-1b and I-2b was applied on the primer layer side of the base material in a manner that the film thickness after drying became 1 μm by using a Meyer bar.

Next, the coating solution was heated at 90° C. for 1 minute using a hot air drying apparatus to remove the solvent contained in the coating solution applied to the base material, and the coating solution was left standing in an environment of 23° C. and a relative humidity of 50% for 7 days to be cross-linked.

Then, on the silicone-based release agent layer side of the release liner, an acrylic pressure sensitive adhesive was applied in a manner that the film thickness after drying became 20 μm. The solvent contained in the coating solution was removed by heating at 90° C. for 1 minute by using a hot air drying apparatus, and thus an acrylic pressure sensitive adhesive layer was formed.

Then, the acrylic pressure sensitive adhesive layer formed on the release liner and a surface, which was opposite to the ink-receiving layer, of the base material were bonded, and thus a sheet for inkjet printing was obtained.

### Measurement of Si Proportion by XPS

For the ink-receiving layer surface of the sheet for inkjet printing, the Si proportion (at. %) was calculated by the following equation based on the counts of silicon atom (Si₂ₚ), carbon atom (C₁ₛ), nitrogen atom (N₁ₛ), and oxygen atom (O₁ₛ) measured by X-ray photoelectron spectroscopy (XPS).

Si proportion (at. %)=[(Si₂ₚ count)/{(C₁ₛ count)+(N₁ₛ count)(O₁ₛ count)+(Si₂ₚ count)}]×100

Note that the Si proportion in Table 2 is an average value of results measured at freely chosen two points of the ink-receiving layer surface.

### Evaluation

Evaluations described in (1) to (3) below were performed.

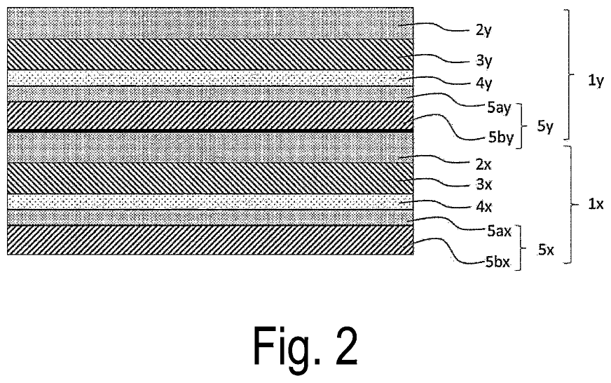

Note that, to perform the evaluation, pretreatment described below was performed on the assumption of contact of the release liner back surface and the ink-receiving layer due to winding of the sheet for inkjet printing. That is, two sheets for inkjet printing that were identical were prepared. As illustrated in FIG. 2, a surface of an ink-receiving layer 2x of a sheet for inkjet printing 1x and a back surface of a release liner 5y of another sheet for inkjet printing 1y were brought into contact and laminated, and were left standing in an environment at a temperature of 70° C. under an applied pressure of 20 kg/cm′ for 12 hours.

### (1) Evaluation of Uneven Printing

On a surface of an ink-receiving layer (A) of a sheet for inkjet printing, a printed portion (printed layer) was formed by an ink jet method with an ink jet printer (HP Latex R2000, available from Hewlett Packard) using latex ink (HP 886, available from Hewlett Packard; ink color: W).

The ink amount of the latex ink was 30%.

The printing conditions were 600 dpi and 17 pass.

After completion of printing, the entire printed surface was visually observed and evaluated based on the following criteria.
Evaluation A: No uneven printing was observed in the entire printed surface.
Evaluation B: Slight uneven printing was observed in a part of the printed surface, but it was not a big issue of the printing quality.
Evaluation C: The difference of density stood out in the entire printed surface, and uneven printing was remarkable.

### (2) Evaluation of Ink Repelling

A printed portion (printed layer) was formed on a surface of an ink-receiving layer of a sheet for inkjet printing by employing the same instruments and conditions as in “(1) Evaluation of uneven printing”.

After completion of printing, the entire printed surface was visually observed and evaluated based on the following criteria.
Evaluation A: In the entire printed surface, no ink void was observed, and ink repelling did not occur.
Evaluation B: Slight ink void was observed, and slight ink repelling occurred.
Evaluation C: Obvious ink void was observed, and ink repelling occurred.

### (3) Evaluation of Ink Adhesion

On a surface of an ink-receiving layer of a sheet for inkjet printing, two layers (lower layer (layer on the side of ink-receiving layer): formed by latex ink 1; upper layer: formed by latex ink 2) of solid coating pattern were simultaneously printed by an ink jet printer (HP Latex R2000, available from Hewlett Packard) using latex ink 1 (HP 882, available from Hewlett Packard; ink color: CMYK) and latex ink 2 (HP 886, available from Hewlett Packard; ink color: W).

The printing conditions were 600 dpi and 31 pass.

Then, an adhesive face of cellophane adhesive tape (Cellotape (trade name) CT405AP, available from Nichiban Co., Ltd.) was attached to a printed surface by fingers, one end of the cellophane adhesive tape was picked up by fingers and peeled off at once, and occurrence of peeling off of the ink was investigated. A sample in which peeling off of the ink did not occur was determined as exhibiting excellent ink adhesion and evaluated as “Evaluation A”. Furthermore, a sample in which peeling off of the ink occurred even slightly was determined as exhibiting poor ink adhesion and evaluated as “Evaluation C”.

The evaluation results are indicated in Table 2.

TABLE 2

| | | | | | | | | | | | | Comparative | |
|---|---|---|---|---|---|---|---|---|---|---|---|---|---|
| | | Examples | | | | | | | | | | Examples | |
| | | I-1 | I-2 | I-3 | I-4 | I-5 | I-6 | I-7 | I-8 | I-9 | I-10 | I-1 | I-2 |
| Composition for forming ink- | | I-1a | I-2a | I-3a | I-4a | I-5a | I-6a | I-7a | I-8a | I-9a | I-10a | I-1b | I-2b |
| receiving layer | | | | | | | | | | | | | |
| Silicone-based leveling agent | | 0.005 | 0.01 | 0.02 | 0.04 | 0.06 | 0.08 | 0.10 | 0.16 | 0.20 | 0.25 | 0.00 | 0.30 |
| content per 100 parts by mass | | | | | | | | | | | | | |
| of resin (part by mass) | | | | | | | | | | | | | |
| Si proportion (at. %) | | — | 0.24 | 0.32 | 0.59 | — | 0.76 | — | 1.45 | 1.52 | 2.1 | 0.22 | 2.4 |
| Evaluation | Uneven printing | B | B | A | A | A | A | A | A | A | A | C | A |
| results | Ink repelling | A | A | A | A | A | A | A | A | A | A | A | C |
| | Ink adhesion | A | A | A | A | A | A | A | A | A | A | A | C |

*“—” means that measurement was not performed.

From the results in Table 2, it was found that Examples I-1 to I-10, in which sheet for inkjet printing having the content of the silicone-based leveling agent of 0.005 parts by mass or greater and less than 0.30 parts by mass per 100 parts by mass of the resin was used, suppressed uneven printing, suppressed ink repelling, and exhibited excellent ink adhesion. In particular, it was found that, when the content of the silicone-based leveling agent was 0.02 parts by mass or greater per 100 parts by mass of the resin, like Examples I-3 to I-10, uneven printing was completely suppressed.

On the other hand, it was found that Comparative Example I-1, in which sheet for inkjet printing having the content of the silicone-based leveling agent of 0 parts by mass per 100 parts by mass of the resin was used, caused uneven printing.

Furthermore, it was found that Comparative Example I-2, in which sheet for inkjet printing having the content of the silicone-based leveling agent of 0.30 parts by mass per 100 parts by mass of the resin was used, caused ink repelling and exhibited poor ink adhesion.

Note that, when the Si proportions (at. %) of Example I-2 and Comparative Example I-1 were compared, there were not much difference. Thus, it was found that, by allowing an extremely small amount of silicone-based leveling agent to be contained, by which not much difference is caused in Si proportions calculated based on measurement results of XPS, effect of suppressing uneven printing was exhibited.

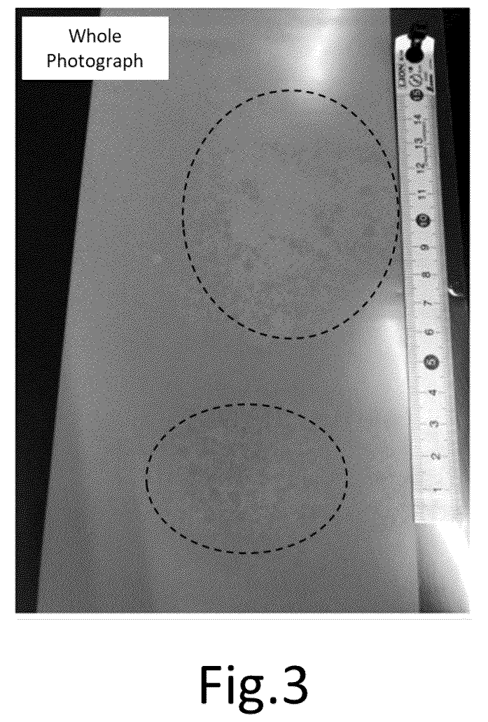

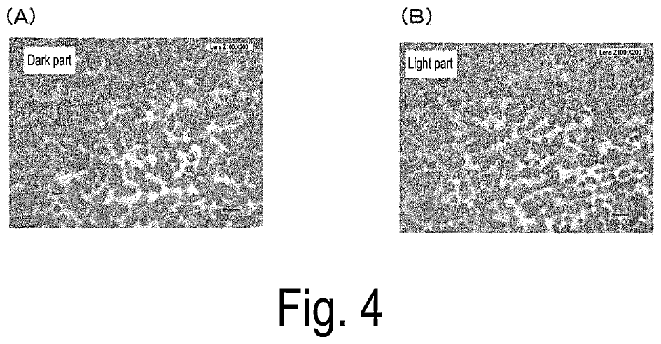

For Comparative Example I-1, in which uneven printing occurred, a whole photograph of the sheet for inkjet printing after the printing is indicated in FIG. 3 as a photograph in place of a drawing. In the whole photograph of FIG. 3, for the parts circled with dotted line where uneven printing occurred, photomicrographs of a dark part and a light part are indicated in FIG. 4 as photographs in place of drawings.

In the photomicrograph of the dark part in FIG. 4, decrease in wettability of dots with respect to the ink-receiving layer was not particularly observed, and dots of the ink interfered adequately. On the other hand, in the photomicrograph of the light part in FIG. 4, due to decrease in wettability of dots with respect to the ink-receiving layer, less interference among dots of the ink occurred. The reason for such a difference regardless of the same printing conditions in the entire surface of the printed surface is presumed to be as follows. When the ink-receiving layer and the release liner back surface are in contact, the extremely small amount of the silicone component transfers to the ink-receiving layer surface, and thus surface free energy changes in a part of the ink-receiving layer surface. As a result, wettability of dots to the ink-receiving layer decreases, thus a region having less interference among dots occurs and causes variation in interference among dots in the ink-receiving layer surface, and the region is visually observed as being faint, and thus uneven printing occurs.

### REFERENCE SIGNS LIST

1 Sheet for inkjet printing
2 Ink-receiving layer
3 Base material
4 Pressure sensitive adhesive layer
5 Release liner
5a Silicone-based release agent layer
5b Support

1. A sheet for inkjet printing, the sheet having a multilayer structure comprising in this order an ink-receiving layer, a base material, a pressure sensitive adhesive layer, and a release liner,
the release liner comprising a silicone-based release agent layer on a contact face with the pressure sensitive adhesive layer,
the ink-receiving layer comprising a composition for forming an ink-receiving layer containing a resin and a silicone-based leveling agent,
wherein a content of the silicone-based leveling agent is 0.005 parts by mass or greater and less than 0.30 parts by mass per 100 parts by mass of the resin.

2. The sheet for inkjet printing according to claim 1, wherein the silicone-based leveling agent is a polyether-modified silicone oil.

3. The sheet for inkjet printing according to claim 1, wherein the sheet is a rolled body obtained by winding into a roll form or a wound body obtained by winding around a core material.

4. A method of use of the sheet for inkjet printing according to claim 1, the method comprising forming a printed portion on Drill the ink-receiving layer of the sheet for inkjet printing by using an ink for inkjet printing.

5. A method for producing a printed article, the method comprising forming a printed portion on the ink-receiving layer of the sheet for inkjet printing according to claim 1 by using an ink for inkjet printing.

6. A printed article comprising a printed portion formed by an ink for inkjet printing provided on the ink-receiving layer of the sheet for inkjet printing according to claim 1.
